(19) United States
(12) Patent Application Publication
(10) Pub. No.: US 2026/0363431 A1
(43) Pub. Date: Nov. 19, 2026

(54) METHOD AND APPARATUS FOR COOPERATIVE CONTROL OF ROBOTIC FURNITURE

(71) Applicant: KOREA INSTITUTE OF SCIENCE AND TECHNOLOGY, Seoul (KR)

(72) Inventors: Sona KWAK, Seoul (KR); Dahyun KANG, Seoul (KR); Yoonseob LIM, Seoul (KR); Wooick JO, Seoul (KR); Nayoung LEE, Seoul (KR)

(73) Assignee: KOREA INSTITUTE OF SCIENCE AND TECHNOLOGY, Seoul (KR)

(21) Appl. No.: 19/293,251

(22) Filed: Aug. 7, 2025

(30) Foreign Application Priority Data
May 19, 2025 (KR) 10-2025-0064528

(51) Int. Cl. A47B 9/20; A47B 1/08; G05D 3/12; G06V 20/50; G06V 40/20

(52) U.S. Cl. CPC A47B 9/20; G05D 3/12; G06V 20/50; G06V 40/20; A47B 1/08; A47B 2200/0056; A47B 2200/0061; A47B 2200/0062

(57) ABSTRACT

The present disclosure relates to a technology for controlling a robotic product, and a method for cooperative control of robotic furniture by a control apparatus includes recognizing a situation relating to a user and an object within a space, determining a spatial requirement required for the user, based on the recognized situation, selecting a spatial service cooperatively provided by a plurality of robotic furniture modules in response to the determined spatial requirement, and instructing each of the plurality of robotic furniture modules for cooperatively providing the selected spatial service to perform the service.

### CROSS-REFERENCE TO RELATED APPLICATIONS

This application claims the benefit of Korea Patent Application No. 10-2025-0064528, filed on May 19, 2025, which is incorporated herein by reference for all purposes as if fully set forth herein.

### BACKGROUND

### Field

The present disclosure relates to a technology for controlling robotic products, and more particularly, relates to a method for cooperative control of robotic furniture that configures furniture required for a user or within a space by using multiple robot modules, and a recording medium on which the method is recorded, and an apparatus.

### Description of Related Art

Due to a recent rapid progress in urbanization and a denser population resulting therefrom, residential spaces have continuously been miniaturized, especially in large cities. One of residential types attracting attention in this trend is a “micro apartment” which refers to an ultra-small residential space having a significantly smaller area than existing general apartments but still equipped with independent living functions. Main targets of the micro apartments are particularly single households, newlyweds, and short-term residents. Owing to advantages of space efficiency and cost savings, there is an increasing demand on the micro apartments. However, this type of residential spaces has limitations in fulfilling physical functions due to size restrictions, which can directly or indirectly affect life quality of residents. One of biggest tasks in the ultra-small residential space is to satisfy various living functions in a unique space. That is, a single room often needs to simultaneously serve multiple roles, such as a bedroom, a living room, a kitchen, a study room, and a dressing room, and these multiple functions are less likely to be achieved without flexibility in space utilization. In fact, many single households limitedly carry out or completely give up various daily life activities, such as eating, exercising, reading, inviting friends, and enjoying hobbies, due to the limited residential space. As a result, the residential spaces are merely places for sleeping or minimal personal relaxation, and residents have difficulties in reflecting their lifestyles and preferences in the residential spaces.

In addition, space constraints have a negative impact not only on physical discomfort but also on psychological aspects. For example, in a case where an attempt to arrange additional furniture or to diversify the interior is failed due to a lack of spaces, residents may lose opportunities for self-expression, which is not desirable in terms of identity formation or well-being. Furthermore, an environment having difficulties in inviting other person may hinder formation of social interactions and emotional bonds in private spaces, and may act as a factor which deepens social isolation.

In order to solve this issue, various technical attempts have been made to improve space utilization. One of these attempts is to develop ‘transformable furniture’. This transformable furniture is a type of furniture that may be structurally transformed according to user's needs to save spaces or change functions, such as a bed stored on a wall and unfolded when necessary, a rotatably transformed desk, a dining table, and height-adjustable furniture using a lifting device. This transformable furniture provides a visible space acquisition effect, and has contributed to a certain level of utilization by reducing space occupancy when not in use. The related art document below presents retractable furniture that may be rotated, opened, and closed to efficiently use spaces by using a driving apparatus such as a motor.

However, most of existing transformable furniture is provided, based on passive operation methods, and a range of structural transformation is limited. In most products, a single unit is only folded or unfolded into a specific structure, and new functions created through interaction or combination between multiple pieces of furniture are not considered. In addition, furniture installed at a fixed position cannot flexibly respond to changes in user movements or activity patterns, which may lead to a standardized spatial configuration. Above all, the existing technology lacks a concept of “role change” or “functional collaboration” of the furniture itself, and has limitations in achieving variability and multiple functions.

Therefore, in order to actively respond to various lifestyles and environmental changes even within limited spaces, there is a gradually emerging need for a technology in which individual furniture may be autonomously transformed and new spatial functions or combinations may be created in cooperation with another furniture. In particular, a modular furniture system based on a robotic technology and control algorithms presents a possibility of realizing a true sense of ‘flexible space’ by self-adjusting and reconfiguring the modular furniture system according to a user's purpose and environment beyond simple space savings. The technology is expected to play a key role in various fields in the future, such as smart homes, high-density urban housing, and mobile housing platforms.

### SUMMARY

The technical aspects to be achieved by the embodiments of the present disclosure are to overcome limitations of transformable furniture introduced due to restrictions on residential spaces, which mostly relies on a passive operation and whose function is limited to changing a shape of a single furniture unit. The technical aspect is to solve a problem that the transformable furniture fails to actively respond to a user's purpose or a change in the environment since autonomous cooperation or reconfiguration is not available between multiple furniture units, and to prevent the inconvenience of directly inputting a user's intention or command to driving means in order to operate the transformable furniture.

According to an embodiment of the present disclosure, in order to achieve the technical aspects, there is provided a method for cooperative control of robotic furniture by using a control apparatus having at least one processor. The method includes a step of causing the control apparatus to recognize a situation relating to a user and an object within a space, a step of causing the control apparatus to determine a spatial requirement required by a user, based on the recognized situation, a step of causing the control apparatus to select a spatial service cooperatively provided by a plurality of robotic furniture modules in response to the determined spatial requirement, and a step of causing the control apparatus to instruct each of the plurality of robotic furniture modules which cooperatively provide the selected spatial service to perform the service.

In the method for cooperative control of robotic furniture according to an embodiment, the step of recognizing the situation may include a step of collecting at least one of image data, voice data of a user, and environmental data for a space by using a sensor, a step of acquiring, from the collected data, at least one situational information from among the number of users within the space, a user's individual behavior, a behavior targeting an object of the user, a usage or a quantity of a target objects, a distance between the user and the target object, and an available area within the space, and a step of recognizing a situational context for the user or the target object within the space, based on the acquired situational information.

In the method for cooperative control of robotic furniture according to an embodiment, the step of determining the spatial requirement may include a step of determining a spatial requirement suitable for the user within the space with reference to a goal corresponding to the recognized situation and the number of recognized users from among a plurality of spatial requirements set in advance for the space.

In the method for cooperative control of robotic furniture according to an embodiment, the step of selecting the spatial service may include a step of determining a spatial service corresponding to the spatial requirement from among spatial service candidates provided in cooperation with the plurality of robotic furniture modules, and a step of outputting a combination of the robotic furniture modules to achieve the selected spatial service.

In the method for cooperative control of robotic furniture according to an embodiment, the step for indicating the execution of the service includes a step of instructing each of the plurality of robotic furniture modules to be moved, arranged, transformed, or coupled to achieve the selected spatial service, and controlling the robotic furniture modules to perform sequential or parallel operations in cooperation with each other.

Furthermore, hereinafter, there is provided a computer-readable recording medium that stores a program recorded for causing a computer to execute the method for cooperative control of robotic furniture.

According to an embodiment of the present disclosure, in order to achieve the technical aspects, there is provided an apparatus for cooperative control of robotic furniture. The apparatus includes a communication unit configured to receive an input of collected data or to communicate with a plurality of robotic furniture modules, and a processor configured to perform cooperative control of the plurality of robotic furniture modules. The processor executes commands including recognizing a situation relating to a user and an object within a space, determining a spatial requirement required by a user, based on the recognized situation, selecting a spatial service cooperatively provided by the plurality of robotic furniture modules in response to the determined spatial requirement, and instructing each of the plurality of robotic furniture modules for cooperatively providing the selected spatial service to perform the service.

In the apparatus for cooperative control of the robotic furniture according to an embodiment, the processor may recognize the situation by collecting at least one of image data, voice data of a user, and environmental data for a space by using a sensor, may acquire, from the collected data, at least one situational information from among the number of users within the space, an individual behavior of the user, a behavior targeting an object of the user, a usage or a quantity of a target objects, a distance between the user and the target object, and an available area within the space, and may recognize a situational context for the user or the target object within the space, based on the acquired situational information.

In the apparatus for cooperative control of robotic furniture according to an embodiment, the processor determines a spatial requirement suitable for the user within the space with reference to a goal corresponding to the recognized situation and the number of recognized users from among a plurality of spatial requirements set in advance for the space.

In the apparatus for cooperative control of robotic furniture according to an embodiment, the processor may select the spatial service by determining a spatial service corresponding to the spatial requirement from among spatial service candidates provided in cooperation with the plurality of robotic furniture modules, and by outputting a combination of the robotic furniture modules to achieve the selected spatial service.

In the apparatus for cooperative control of robotic furniture according to an embodiment, the processor may instruct each of the plurality of robotic furniture modules to be moved, arranged, transformed, or coupled to achieve the selected spatial service, and controlling the robotic furniture modules to perform sequential or parallel operations in cooperation with each other.

According to the embodiments of the present disclosure described above, a user's intention or request is identified without the command of the user by determining the spatial requirement, based on situation recognition, and performing the service is instructed by dynamically selecting the spatial service cooperatively provided by the robotic furniture module. In this manner, a user-oriented spatial service and functional flexibility corresponding to the space may be provided through cooperation and autonomous control between multiple robotic furniture modules.

### BRIEF DESCRIPTION OF THE DRAWING

FIG. 1 is a flowchart showing a method for cooperative control of robotic furniture according to an embodiment of the present disclosure.

FIG. 2 is a diagram for describing a configuration of a spatial service proposed by embodiments of the present disclosure.

FIG. 3 is a flowchart more specifically showing a process of recognizing a situation in the method for cooperative control of robotic furniture in FIG. 1 according to an embodiment of the present disclosure.

FIG. 4 is an diagram showing a technology for performing situation recognition and reasoning.

FIG. 5 is a flowchart more specifically showing a process of selecting the spatial service in method for cooperative control of robotic furniture in FIG. 1 according to an embodiment of the present disclosure.

FIG. 6 is a diagram for describing a process of determining a spatial requirement from the situation recognition and selecting a robotic furniture module.

FIG. 7 is a block diagram showing an apparatus for cooperative control of robotic furniture according to an embodiment of the present disclosure.

FIG. 8 is a diagram for describing a function or an operation performed by each configuration in the apparatus for cooperative control of robotic furniture in FIG. 7 according to an embodiment of the present disclosure.

FIGS. 9A to 9D are diagram showing examples of roles of various furniture that may be realized from a combination or transformation of the robotic furniture modules.

FIGS. 10A and 10B are diagrams showing an example of a Hoberman mechanism for shape transformation of the robotic furniture modules.

FIGS. 11A and 11B are diagrams showing an example of a prototype of a transformable and stackable robotic furniture module.

FIG. 12 is a diagram showing an example of a furniture arrangement for multiple users by using the robotic furniture module adopting the Hoberman mechanism.

### DETAILED DESCRIPTION

The embodiments of the present disclosure proposes a technology for a robotic furniture module and cooperative control which may autonomously change a shape and an array according to a user's situation in order to effectively satisfy multifunctional requirements in a small residential space. In a cooperative control process of the robotic furniture module, various types of information such as the number of users, types of behaviors, and types and the amount of objects in use are recognized to identify a current usage environment, and multiple modules are operated in cooperation with each other such that the multiple modules are transformed into a furniture form suitable for the current usage environment. According to this configuration, various furniture functions such as tables, chairs, storage units, and mobile carts may be dynamically realized within a single system, and user life satisfaction and space utilization may be maximized by supporting various living scenarios only with minimal modules even in limited spaces.

For this purpose, the embodiments of the present disclosure propose a modular structure that recognizes users, objects, and environmental data by itself, identifies a situation, based on a recognition result, thereafter, selects a necessary furniture function in response thereto, and transforms or arranges the furniture to perform the corresponding function. Based on this modular design, a shape of each module may be flexibly transformed, and multiple modules may be coupled to or separated from each other. In this manner, an optimized spatial configuration may be available according to a user's intention even in limited spaces. In particular, unlike traditional furniture having a fixed role, a system of the present disclosure may flexibly switch between various furniture functions, such as chairs, tables, and storage units, through shape transformation of a single module or a plurality of the modules. Therefore, user-oriented functional flexibility may be maximized while spatial constraints are overcome.

The robotic furniture module described in the present disclosure is not a complete piece of the furniture, but is an an autonomous hardware unit that may realize various types of furniture functions through transformation, combination, and movement, as a minimum unit structure for configuring the furniture. Each robotic furniture module internally includes driving means, communication means, and sensing means, may receive a command from an external control apparatus, and may be operated independently or in cooperation with other modules in accordance with the command. The driving means enables movement or shape transformation of the module, and the sensing means collects information on the user or surrounding environments to enable a precise operation according to the situation. In addition, the communication means enables real-time information exchange with the control apparatus and adjacent modules, thereby supporting the organic combination or separation of the plurality of modules as single furniture.

Unlike general furniture having specific functions fixed in advance, the robotic furniture module may have new roles assigned from time to time according to the commands from the control apparatus. For example, even when one module plays a role as a table leg depending on the situation, the one module may be coupled to another module, and may be converted into a storage space or a seat. Therefore, without being limited to a fixed function, the robotic furniture module may variably change a structure and a function according to space needs and user situations. Through this configuration, the robotic furniture module may act as a core component that may effectively provide various furniture functions within a limited space.

Hereinafter, embodiments of the present disclosure will be described in detail with reference to the drawings. However, detailed description of known functions or configurations that may obscure the concept of the embodiments will be omitted in the following description and the accompanying drawings. In addition, in the present disclosure, the term “including” a certain component does not exclude the presence of other components unless otherwise specified, and means a possibility of including additional components.

In addition, the terms “first”, “second”, and the like may be used to describe various components, but the components should not be limited by these terms. The terms may be used to distinguish one component from another component. For example, without departing from the scope of the present disclosure, a first component may be referred to as a second component, and similarly, a second component may be referred to as a first component.

The terms used in the present disclosure are adopted solely to describe specific embodiments, and are not intended to limit the present disclosure. Singular expressions include plural expressions unless the context clearly indicates otherwise. In the present application, terms such as “including” or “provided with” are intended to specify the existence of a specified feature, a number, a step, an operation, a component, a part, or a combination thereof, and should be understood that the terms does not exclude in advance the existence or a possibility of additions of one or more other features, numbers, steps, operations, components, parts, or combinations thereof.

Unless specifically defined, all terms used herein, including technical and scientific terms, have the same meanings as generally understood by those skilled in the art to which the present disclosure pertains. Terms that are generally defined in common dictionaries are to be interpreted as having meanings consistent with meanings used in the context in the related art. Unless explicitly defined otherwise in the present disclosure, the terms shall not be interpreted in an idealized or overly formal meaning.

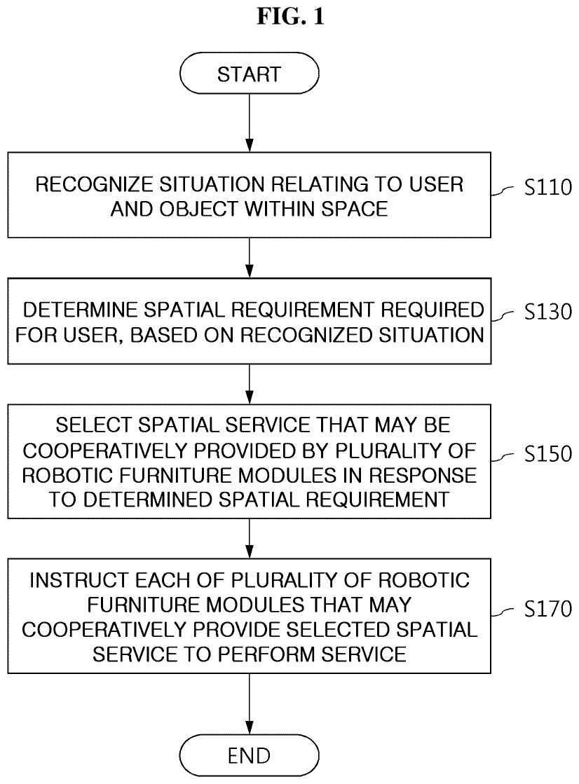

FIG. 1 is a flowchart showing a method for cooperative control of robotic furniture according to an embodiment of the present disclosure. The method may be realized by a control apparatus including at least one processor to process the commands for performing each of steps described below

In Step S110, the control apparatus recognizes a situation relating to a user and an object within a space. In this process, firstly, the control apparatus collects image, voice, environmental information, and the like through a sensor. Based on the collected information, the control apparatus identifies information on the number of persons within the space, behaviors of persons, a usage or a quantity of target objects, a distance between the person and the object, and an available space area. Thereafter, the control apparatus comprehensively analyzes the collected information to understand whether a user is in any situation within a current space.

More specifically, in order to determine a shape and an array of furniture that satisfies a user's intention, first, the control apparatus performs a process of recognizing a situation relating to the user and the object within the space. In this process, the control apparatus collects at least one of image data, voice data, and spatial environment data through one or more sensors. Through this process, the control apparatus acquires basic information for identifying a real-time situation in an indoor space. Thereafter, the collected data is analyzed to derive various situational information such as the number of users present within the space, an individual behavior of the user, a user interaction targeting a specific object, a usage or a quantity of the objects, a distance between the user and the object, and a currently available area within the space. Finally, based on the situational information acquired in this way, the control apparatus recognizes a higher-level situational context relating to the user or the object, which is used as a key determination reference for determining the operation and configuring the arrangement of the robotic furniture modules which are performed later.

In Step S130, the control apparatus determines a spatial requirement required for the user, based on the recognized situation in Step S110. After the process of recognizing the situation, the control apparatus determines which type of spatial configurations is required within the current space, based on the identified situation of the user. For this purpose, the control apparatus may determine a spatial requirement suitable for the user within the space with reference to a goal corresponding to the recognized situation and the number of recognized users from among a plurality of the spatial requirements set in advance for the space.

More specifically, the control apparatus selects the goal most suitable to the currently recognized situation from among various spatial requirement conditions defined in advance for all of the spaces, and determines a proper spatial requirement by considering the number of users present within the space. For example, in a situation where one user is engaged in a reading activity, a quiet and non-interrupted spatial configuration in a form of a private study room may be required. When it is recognized that two or more users prepare food, the control apparatus may determine that a kitchen or dining space configuration where collaboration is available is proper as the spatial requirement. In this manner, the control apparatus comprehensively analyzes the user's purpose and activity, the number of persons, and a spatial condition to determine a purpose and a function of the spatial configuration most suitable for the user at the current time, which becomes a key reference for controlling the movement, transformation, and arrangement of the robotic furniture modules.

Meanwhile, the process of determining the spatial requirement may be performed by being largely divided into two methods depending on behavior types of the user.

The first type refers to a case where the user independently acts without interacting with a specific object. For example, the first type corresponds to an individual behavior such as meditation, stretching, reading, and resting, in which the behavior of the user does not directly affect surrounding objects. In this case, the control apparatus calculates a minimum space required for each individual to perform the activity in proportion to the number of users, and controls the robotic furniture to achieve the spatial configuration corresponding to the minimum space. For example, when two users are each reading and meditating, the space is divided so that both the two users are provided with an independent and quiet space which may be comfortably used by the two users. In summary, in a case where the user's action is an individual behavior in the recognized situation, the control apparatus may calculate the space required for the individual behavior in proportion to the number of corresponding users.

The second type refers to a case where the user performs activities on a specific object. The second type corresponds to a situation where the user handles tableware or cooking utensils for meal preparation, or a case where the user uses a laptop or an item on a desk during office work. For these object-targeted behaviors, the control apparatus calculates the space required for performing the task by considering various factors such as a usage, a quantity, and a size of the object, and a distance from the user, rather than simply based on the number of users. For example, in a situation where three users prepare a meal together, the control apparatus determines that a kitchen space having a size and a shape suitable for collaboration is provided by considering food ingredients, cooking utensils, and movement paths. In summary, in a case where the behavior of the user is an object-targeted behavior in the recognized situation, the control apparatus may calculate the space required for performing the task on the target object.

In this way, the robotic furniture system not only recognizes the behaviors of the user, but also realizes a spatial configuration optimized for each situation by thoroughly analyzing effects of the behaviors on the space and requirement conditions.

In Step S150, the control apparatus selects a spatial service that may be cooperatively provided by a plurality of the robotic furniture modules in response to the spatial requirement determined through Step S130. When the spatial requirement is determined, the control apparatus selects the spatial service most suitable for the requirement from among various spatial service candidates that may be cooperatively provided by the plurality of robotic furniture modules. Various spatial services may be considered according to the situation of the user, and a proper module combination may be determined to satisfy the required furniture function and arrangement according to the selected service. The control apparatus analyzes a current state and a current function of each module, calculates an optimal combination, and controls the modules to be organically cooperated to enable a user-customized spatial configuration.

More specifically, after the spatial requirement is determined, the control apparatus performs a process of selecting a specific spatial service that can satisfy the requirement. In this process, first, various spatial service candidates that may be cooperatively provided by the plurality of robotic furniture modules are considered. For example, various service types such as “a dining space”, “a work space”, “a rest space”, and “a storage space” are defined in advance, and each service requires a furniture combination of specific shapes and arrangements. The control apparatus may determine the spatial service most suitable for the current situation of the user by comparing and analyzing the previously determined spatial requirements and the spatial service candidates.

Thereafter, the control apparatus determines which robotic furniture modules need to be cooperated to realize the selected spatial service, and outputs a combination result of the robotic furniture modules. In this case, the control apparatus comprehensively considers a current position, a function, and an operable range of each module to calculate an optimal combination. For example, when the “work space” is selected, the control apparatus controls an arrangement of the robotic furniture modules by coupling a module that can serve as a desk, a module that can provide a chair function, and a module that can offer lighting. Through this process, beyond a simple operation of the individual module, the robotic furniture system may dynamically configure a user-customized space in which the plurality of modules are organically cooperated with each other.

In Step S170, the control apparatus instructs each of the plurality of robotic furniture modules that can cooperatively provide the spatial service selected through Step S150 to perform the service. When the selected spatial service is determined, the control apparatus instructs specific operations to each of the plurality of robotic furniture modules required for realizing the service. In this case, the control apparatus individually transmits operation commands such as the movement, the arrangement, the transformation, or the combination in view of a role, a position, and a functional characteristic of each module, and coordinates overall service goals to be smoothly achieved. This operation is controlled so that each module does not simply move independently, but rather cooperates with each other sequentially or in parallel. For example, when a table is configured, a base module is first positioned, thereafter, sequential instructions are made to combine an upper plate module, or various modules may are simultaneously moved to be harmoniously operated in parallel to form a single shape. Through this process, the robotic furniture system may accurately and stably realize various spatial services, and may configure a flexible space, based on cooperative control.

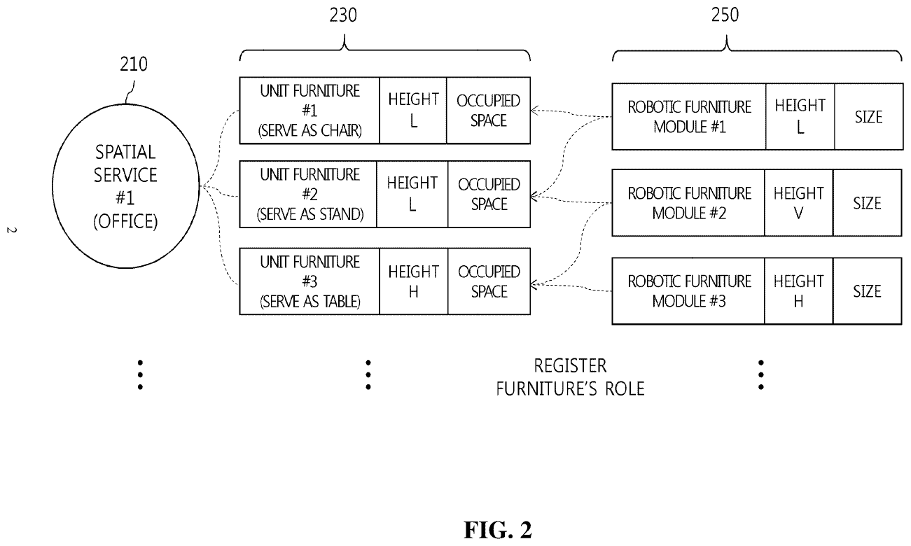

FIG. 2 is a diagram for describing a configuration of the spatial services proposed by the embodiments of the present disclosure, and shows an example of a spatial service 210 referred to as an “office”.

First, a plurality of unit furniture items 230 that configure the spatial service referred to as the “office” may be matched. Each of the unit furniture items may be set in response to the various furniture roles required for a space referred to as the “office”. For example, unit furniture items that fulfil a roles of a “chair”, a “stand”, a “table”, and the like may be included. A required height of furniture may be set for each of the unit furniture items. In the following embodiments, two types of furniture including high (H) furniture and low (L) furniture will be described as examples. For example, the high furniture may have a height suitable for performing the task with both hands while the user is seated on a standing-type chair, such as at a table or dining table. In addition, the low furniture may have a height of a seat on which the user may be seated, such as a chair or a stool. Furthermore, each of the unit furniture items may be used as a basis for determining whether each of the unit furniture items may be properly arranged in a given indoor space by calculating an occupied space.

Next, one or more robotic furniture modules 250 may be matched to the unit furniture items 230 to register a role of the furniture. As described above, the robotic furniture module is not a complete piece of furniture, but a hardware unit that may realize various types of furniture functions through transformation, combination, and movement, as a minimum unit structure for configuring the furniture. Each module may have a height corresponding to the unit furniture. Here, three main types of heights will be described as examples. That is, the three types include a high (H) furniture module, a low (L) furniture module, and a furniture module having a variable height (V).

The robotic furniture module having the variable height is a component designed to actively adjust a total height of the module depending on a purpose of use and a spatial configuration. The furniture module having the variable height is mainly realized through an internally installed lifting mechanism, and the mechanism may include a driving device such as an electric actuator, a linear motor, a gear-type lifting device, or a hydraulic or pneumatic cylinder. The module is precisely moved in an upward-downward direction in accordance with the commands provided from the control apparatus, and is transformed into forms that may satisfy various height requirements, such as a table upper plate support, a seat, a storage table, or a simple work table, depending on the situations. In addition, in some cases for realization, mechanisms such as a telescopic structure or a zigzag lifting frame may be applied in parallel to ensure stability and structural strength in a process of adjusting the height, and the furniture module may be accurately adjusted to a desired height through a sensor-based position feedback system. Through this configuration, the robotic furniture module having the variable height may smoothly support the user to switch between a plurality of furniture types, and may maximize space utilization within a small space.

Meanwhile, the robotic furniture module 250 configured in this way may have a size value assigned by a manufacturer. The size value may be set by a height, a width, and a depth of the furniture, and in a case of the furniture module having the variable height, the furniture module may be set to a range value other than a fixed value. An occupied space of the unit furniture 230 may be determined depending on the size of the robotic furniture module 250.

The embodiments of the present disclosure may express the roles of the furniture required for the space from a combination of multiple robotic furniture modules through a spatial service setting method for this structure, and may assign individual furniture modules corresponding to the roles of the furniture.

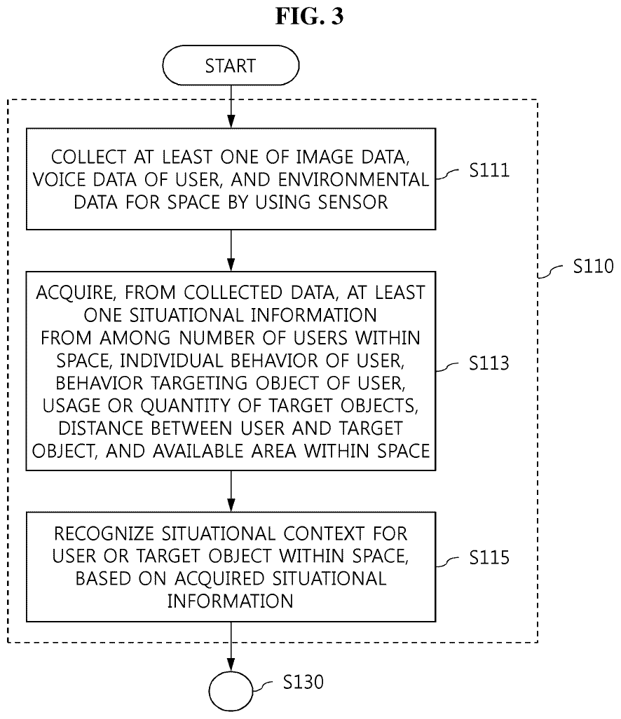

FIG. 3 is a flowchart more specifically showing a process of recognizing a situation (Step S110) in a method for cooperative control of robotic furniture in FIG. 1 according to an embodiment of the present disclosure.

In Step S111, at least one of image data, voice data of the user, and environmental data for the space may be collected by using the sensors. In this process, at least one of the image data, the voice data of the user, and the environmental data for the space, such as a temperature, illuminance, and noise, is collected through various sensors installed in the system. For example, the image data may be used to identify a location or a movement of the user, the voice data may be used to recognize an interaction with the user or a specific command, and the environmental data may be used as a reference for determining usability and conditions of the current space.

In Step S113, situational information may be acquired from collected data, such as at least one of the number of users within the space, the individual behavior of the user, the behavior targeting the object of the user, the usage or the quantity of the target objects, the distance between the user and the target object, and the available area within the space. More specifically, the data collected in the previous step is analyzed to derive more detailed situational information. The situational information includes various factors such as the number of users within the space, an individual activity of the user, the behavior targeting specific furniture or object (for example, putting an object in a storage cabinet or working on a desk), the usage or the quantity of the target objects, the distance between the user and the object, and the free area currently available within the space. This information serves as essential fundamental data for understanding a usage pattern and the purpose of the space beyond a level of simple detection.

In order to provide an optimized spatial function to the user, the modular robotic furniture system proposed by the embodiments of the present disclosure includes a function of collecting the environmental data on a real-time basis, and recognizing and determining the situation by using the sensor, based on the environmental data. Specifically, the system collects at least one of the image data, the voice data, and the environmental data by using a image sensor, a microphone, and an environmental detection sensor (such as LiDAR), and acquires various situational information such as the number of users, whether the user acts alone or interacts, the type and the quantity of the objects in use, the distance between user and the object, and the available area within the space. The acquired information is input to an internal situation determination model, and is used to determine a furniture configuration and an operation method which are suitable for the current usage environment. Examples of a situation determination technology and situational information for each type of the collected data described above are shown in the following table.

TABLE 1

| | Examples of Situation | Examples of Situational |
|---|---|---|
| Classification | Determination Technology | information |
| Voice data | Speaker identification | The number of speaker, |
| | model | emotion of speaker, |
| | Voice recognition (STT) | requirement of speaker, |
| | model | relationship between |
| | Text mining ‘sentiment | speakers |
| | analysis’ | |
| Image data | Analysis of point cloud | Available area, the number |
| | obtained from LiDAR | of users, emotion of user, |
| | Google MediaPipe | hand gesture of user |
| | TensorFlow hand pose- | |
| | detection | |

Referring to Table 1, in a case of the voice data, a speaker may be identified by analyzing voice conversations between the users which are collected through a microphone attached to the robotic furniture, and a tendency of speech content may be determined through voice recognition and an emotion analysis model. In a case where two speakers are identified and the content of the conversation is mainly classified into a positive emotion, the system may determine that a relationship between the users is intimate, and may select an arrangement in which a single table is shared by the users. On the other hand, when an emotional distance is recognized, a furniture arrangement may be adjusted to configure an individual activity space by providing each user with an independent table.

Meanwhile, in Table 1, the image data may be collected on a real-time basis through the camera and LiDAR which are mounted on the robot. In addition, the number and the position of the users may be identified by using a face detection technology such as Google MediaPipe, an available area having no obstacle may be calculated on a real-time basis through a point cloud analysis. The system assigns and arranges a proper number of the robotic furniture modules by comparing the area secured within the current space and the number of users. This determination is made by a probability-based determination mechanism defined inside the system, and the service that satisfies the user's purpose and the spatial condition may be provided by comprehensively considering the function, the quantity, and the arrangement method of the furniture required depending on the situation.

In Step S115, the situational context for the user or the target object in the space may be recognized, based on the situational information acquired through Step S113. For example, in a case where the user sits at a desk while a laptop and lighting are provided nearby, the system may interpret the situation as a “situation requiring a work space”. Through this context recognition, beyond a simple operation, the robotic furniture system may predict the intention and the need of the user, and may actively configure the suitable space.

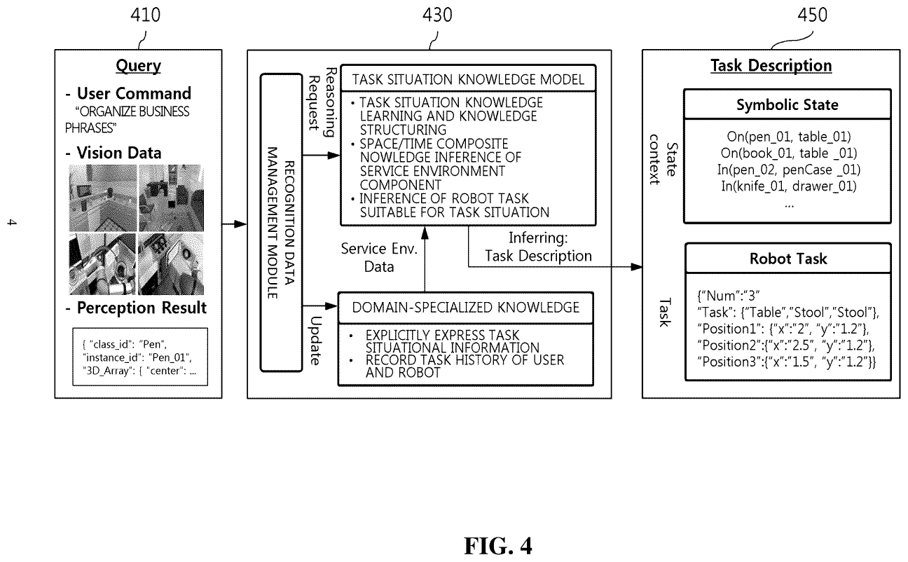

FIG. 4 is a diagram showing a technology for performing situation recognition and inference. The modular robotic furniture system of the present disclosure includes a control mechanism based on situation recognition and inference to intelligently respond to commands of the user or environmental changes.

For this purpose, the system first starts a procedure by receiving a query from the user or the environment. A query 410 may include not only a user command such as a simple voice command, but also vision data collected through the camera and the sensor, and a perception result generated during a pre-detection and analysis process of the system. These are all important clues for understanding the context of the task to be performed by the robotic furniture.

The query information 410 is transmitted to a recognition data management module 430, and is processed as a refined input for an inference process subsequent thereto. A recognition data management module transmits a reasoning request to a task situation knowledge model by reflecting service environment data together with the data collected so far. In this case, the service environment data includes information such as a structure, lighting, and a user lifestyle patterns in a specific space where the robotic furniture is located, and is continuously updated, based on a domain-specific knowledge.

The task situation knowledge model may be realized as an AI-based knowledge structure, and may be configured in a form utilizing ontology or a large language model (LLM). This knowledge model does not simply rely on fixed rules, but has the characteristic of being able to perform high-level semantic inference by understanding and synthesizing various contextual information. Furthermore, the domain-specific knowledge may be managed in a form of a knowledge graph specialized for the service domain, and spatial information on then surrounding environment of the robot, records of interactions with the user, and a past task history are also stored together to enhance accuracy and effectiveness of inference.

After a series of these processes, the task situation knowledge model outputs a task description 450. The task description includes a state context for describing the current situation and a task to be performed by the system. For example, the state context may include information such as “two users conversate with each other before a meal, and the available area of the space is limited”, and based on this information, a task instruction such as “arrange a common table at the center and arrange chairs on both sides” may be derived.

As a result, the robotic furniture system enables a user-oriented adaptive spatial configuration even in dynamic and complex living environments by realizing an autonomous determination function through situation understanding and knowledge-based inference beyond simple input-based command execution.

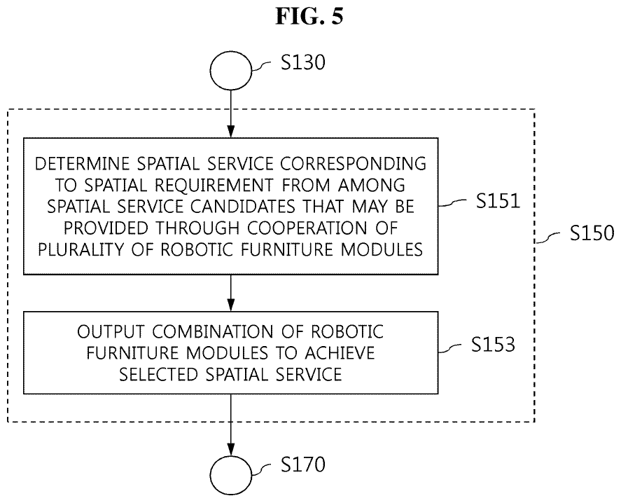

FIG. 5 is a flowchart more specifically showing a process (S150) of selecting the spatial service from the method for cooperative control of robotic furniture in FIG. 1 according to an embodiment of the present disclosure. Based on the previously recognized situation and determined spatial requirement, a selection process is performed to provide the spatial service most suitable for the user's purpose. This process largely includes two detailed steps, and includes a step (S151) of determining each spatial service and a step (S153) of determining a module combination capable of realizing the service.

In Step S151, the spatial service corresponding to the spatial requirement may be determined from among spatial service candidates that may be provided through the cooperation of the plurality of robotic furniture modules. In this process, the service most suitable for the spatial requirement of the user is selected from various spatial service candidates that may be provided by the current system. In this case, the spatial service candidates include various scenarios defined according to user activities, such as providing a dining space, configuring a rest space, configuring a work space, and securing a storage space. The system compares and analyzes a degree of suitability between the functional characteristics that each candidate service can satisfy and the requirement of the current user, and selects the optimal spatial service by considering spatial constraint (for example, the available area, the number of users, the number of usable modules, or the like). The determination is made based on a priority-based service evaluation mechanism that reflects a past selection history, a user preference, a time zone, and a contextual factor in similar situations in the past.

In Step S153, a combination of the robotic furniture modules selected through Step S151 to achieve the spatial service may be output. In this process, it is determined that any robotic furniture modules cooperate with each other to actually realize the selected spatial service. That is, functional elements required for executing the service are analyzed, and a combination of the robotic furniture modules that may execute the service is configured and output. For example, in a case where a “dining space service” is selected, one module capable of serving as a table upper plate, two modules transformable into a chair, and one auxiliary storage module may be selected as one combination. In this case, the combination is optimized on a real-time basis by comprehensively considering factors such as a current position, mobility, a battery level, and a mechanical condition of each module, and may be configured to be automatically replaced with a replacement module that may fulfill the same function when necessary.

In this way, the robotic furniture system realizes flexible and intelligent service selection and a module combination configuration function by accurately reflecting user requirements according to the situation, may configure an effective and adaptive environment even within the complex spaces.

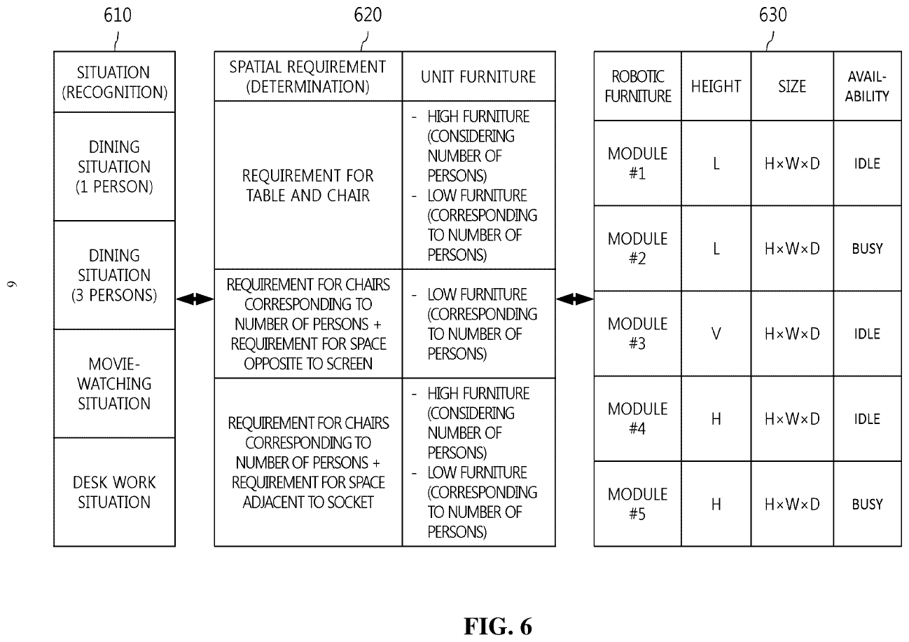

FIG. 6 is a diagram for describing a process of determining the spatial requirement from situation recognition and selecting the robotic furniture module.

In the method for cooperative control of robotic furniture modules according to embodiments of the present disclosure, the spatial service corresponding to a spatial requirement 620 is determined, and thereafter, a robotic furniture module 630 is matched. For this purpose, the spatial service that may achieve the spatial requirement within the actual space may be determined through the movement or the transformation of the robotic furniture modules from among the spatial service candidates that may be provided through the cooperation of the plurality of the robotic furniture modules with reference to the available space identified in a recognized situation 610.

Referring to FIG. 6, a “dining situation (1 person)” or a “movie-watching situation” is shown as an example for the recognized situation 610, and “a requirement for a table and a chair” or “a requirement for chairs corresponding to the number of persons+a requirement for a space opposite to the screen” is shown as an example as a corresponding spatial requirement 620. In addition, at least one unit furniture according to each spatial requirement is matched. Whereas both high furniture and low furniture are required in response to the dining situation, only low furniture modules may be set in response to the movie-watching situation. Subsequently, a process of matching a previously set spatial requirement 620 for an individual robotic furniture module 630 is performed. Since a type of the unit furniture is specified according to the spatial requirement, a suitable furniture module may be selected. In this case, a height, a size, and an idle state of the furniture is may be considered.

Examples of matching results for each goal in the process of spatial requirement determination and robotic furniture module selection is shown in Tables 2 to 4.

TABLE 2

| | | Spatial | | Low |
|---|---|---|---|---|
| | Situation | requirement | High furniture | furniture |
| Goal | (recognition) | (determination) | module | module |
| Providing | The number of | Table and chair | Move one | Move one |
| dining space | persons: one | for one person are | unit to space | unit along |
| (one person) | person | required | suitable for | with tall |
| | Object: | Identifying | dining | module |
| | operation of | standby furniture | | |
| | cooking utensils | Command for | | |
| | →Dining | moving and | | |
| | situation for one | arranging required | | |
| | person | furniture modules | | |
| Providing | The number of | Table and chairs | Move one | After moving |
| dining space | persons: two to | for two to four | unit to space | two to four |
| (two to four | four persons | persons are | suitable for | units along |
| persons) | Object: | required | dining | with tall |
| | operation of | Identifying | Expand | module, |
| | cooking utensils | standby furniture | module to | Arrange units |
| | →Dining | Command for | enable dining | to enable users |
| | situation for two | moving and | for two to four | to sit facing |
| | to four persons | arranging required | persons | each other |
| | | furniture modules | | |
| Providing | The number of | Table and chairs | Move two | Arrange five |
| dining space | persons: five or | for five or more | units to space | or more units |
| (five or more | more persons | persons are | suitable for | around |
| persons) | Object: | required | dining | coupled high |
| | operation of | Identifying | Coupling two | module |
| | cooking utensils | standby furniture | modules After | according to |
| | →Dining | Command for | expanding | the number of |
| | situation for five | moving and | modules to | persons. |
| | or more persons | arranging required | enable dining | |
| | | furniture modules | for five or more | |
| | | | persons | |

Table 2 shows the results of situation recognition, and the corresponding spatial requirements and furniture module matching, in accordance with the goal of providing a dining space and variations in the number of persons. It may be seen that two types of furniture modules with different heights are required for dining.

TABLE 3

| | | Spatial | High | |
|---|---|---|---|---|
| | Situation | requirement | furniture | Low furniture |
| Goal | (recognition) | (determination) | module | module |
| Providing | The number of | Chairs | — | Arrange |
| movie- | persons: one to | corresponding to | | modules in |
| watching | four persons | the number of | | single row |
| space | Object: lights | persons are | | corresponding to |
| (one to four | off, projector on | required | | the number of |
| persons) | →Movie- | Identifying | | persons to enable |
| | watching | standby furniture | | all persons to |
| | situation | Command for | | view screen |
| | | moving and | | |
| | | arranging required | | |
| | | furniture modules | | |
| | | to wall opposite to | | |
| | | screen | | |
| Providing | The number of | Chairs | — | Arrange |
| movie- | persons: five or | corresponding to | | modules in |
| watching | more persons | the number of | | staggered |
| space | Object: lights | persons are | | configuration |
| (five or more | off, projector on | required | | with two to four |
| persons) | →Movie- | Identifying | | units in front |
| | watching | standby furniture | | row and three to |
| | situation | Command for | | four units in |
| | | moving and | | back row to |
| | | arranging required | | enable all |
| | | furniture modules | | persons to view |
| | | to wall opposite to | | screen |
| | | screen | | |

Table 3 shows results of situation recognition in which the number of persons varies in accordance with a goal of providing a movie-watching space, the corresponding spatial requirement, and furniture module matching. In this case, a high furniture module is not needed.

TABLE 4

| | | Spatial | | Low |
|---|---|---|---|---|
| | Situation | requirement | High furniture | furniture |
| Goal | (recognition) | (determination) | module | module |
| Providing | The number of | Table and chairs | Move one unit | Arrange low |
| study space | persons and | corresponding to | to space suitable | module |
| (discussion, | speech | the number of | for studying | around high |
| meeting) | Objects: | persons are | Expand or | module to |
| | laptop, book, | required | contract modules | correspond to |
| | paper, pen, and | Identifying | in accordance | number of |
| | the like | standby furniture | with the number | persons |
| | → desk work | Command for | of objects held by | |
| | situation | moving and | users | |
| | | arranging required | | |
| | | modules to | | |
| | | position adjacent | | |
| | | to bookshelf and | | |
| | | socket | | |
| Providing | The number of | Table and chairs | Move modules | Arrange |
| study space | persons and | corresponding to | to space suitable | every one low |
| (individual | speech | the number of | for studying | module per |
| study) | Objects: | persons are | corresponding | one high |
| | laptop, book, | required | to number of | module |
| | paper, pen, and | Identifying | persons (three | |
| | the like | standby furniture | persons - moving | |
| | → desk work | Command for | three modules) | |
| | situation | moving and | | |
| | | arranging required | | |
| | | modules to | | |
| | | position adjacent | | |
| | | to bookshelf and | | |
| | | socket | | |

Table 4 shows results of situation recognition depending on a detailed purpose in the space in accordance with a goal of providing a study space, and the corresponding spatial requirement, and furniture module matching. A configuration of the furniture module varies depending on whether the task is carried out by the users together or whether the task is individually performed by the user

The method for cooperative control of robotic furniture according to embodiments of the present disclosure may effectively generate a combination suitable for the spatial service from multiple robotic furniture modules classified based on the furniture height. For the furniture module configuration depending on the height, the following process may be performed in advance in outputting the combination of the robotic furniture modules.

First, the robotic furniture module existing within the space may be classified in advance into a first height type for providing a seating space to the user and a second height type for providing a work space to the user. The height type classification is used as basic information for more precisely realizing the spatial function according to an activity purpose of the user.

Next, a plurality of the robotic furniture modules suitable for the spatial service are retrieved with reference to the first height type and the second height type. That is, when a specific spatial service is selected, multiple candidate furniture modules are retrieved with reference to a height type suitable for the service, and whether the candidate furniture module is actually available for use is determined, based on availability conditions. For example, whether each module may be moved, transformed, or coupled, and whether a space for performing the operation is sufficiently secured within the currently recognized available space are considered together.

Subsequently, a combination of available resources may be output by checking availability of the retrieved robotic furniture module. More specifically, in a case where the robotic furniture module is moved, arranged, transformed, or coupled to perform the service, the available resources may be filtered by checking whether the required space is sufficient within the available space according to the recognized situation. Thereafter, in a case where there are a plurality of the combinations of filtered available resources, a combination having a smallest total cost required for performing the service may be selected for each combination of the available resources. That is, an optimal furniture configuration is achieved by calculating costs based on a moving distance, energy consumption, a work time, and the like which are consumed to perform the service for each combination, and by selecting a most efficient combination in the combinations. This configuration enables a user-customized furniture arrangement that satisfies both functionality and efficiency even within a limited space.

In the robotic furniture system according to embodiments of the present disclosure, in a case where a plurality of combinations of filtered available modules exist, the cost for performing the service is calculated for each module combination, and the combination having the smallest sum of costs may be selected. In order to more specifically realize the system, a cost-based optimization technique may be applied to the task assignment for each robotic furniture module.

For example, in a case where a task list for configuring a specific spatial service is inferred, an assignment cost may be calculated for each task to select a proper robot to perform the task. In this case, a decision variable may be defined to indicate whether a robot i performs a task k, and the variable may have a binary value (for example, 1: assigned, 0: not assigned). For each robot, a cost function may be defined by comprehensively considering a moving distance, energy consumption, an estimated required time, and a required degree of cooperation which are required for performing the task k.

From a viewpoint of the overall system, total costs for all pairs of robot-task may be modeled in the following form:

$$Minimize {\sum }_{i = 1}^{N} {\sum }_{k = 1}^{K} {c}_{i}^{k} ( {x}_{i}^{k} ) \qquad [ Expression 1 ]$$

Here, N represents the number of the robotic furniture module, and K represents the number of tasks.

In this case, as a constraint condition, each task is required to be assigned to one robot, and each robot may have a limitation on the number of tasks that may be simultaneously performed. Through an optimization method based on cost minimization as described above, the system may maximize overall service efficiency by selecting the robot i having a lowest cost for the given task k and by assigning the task to the robot.

In a case where there are a plurality of the robotic furniture modules capable of fulfilling the same function, this method is particularly useful for realizing a cooperative control strategy that minimizes resource consumption required for providing the service and satisfies both space utilization and user convenience.

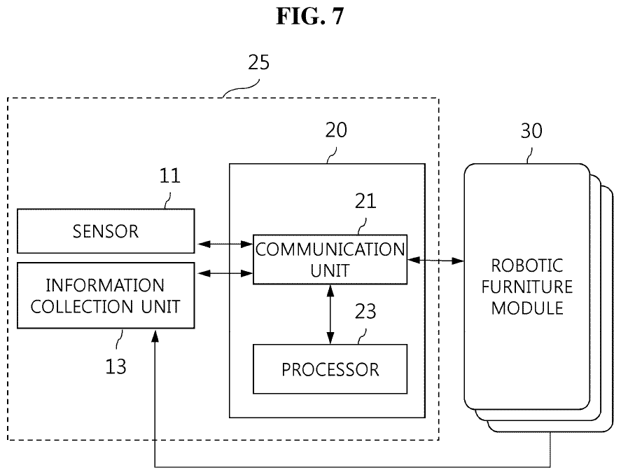

FIG. 7 is a block diagram showing an apparatus for cooperative control of the robotic furniture 20 according to an embodiment of the present disclosure, and the cooperative control method in FIG. 1 from a viewpoint of a time series processing flow is reconstructed from a viewpoint of a hardware configuration. Therefore, herein, only the function or the operation of each configuration will be briefly described to avoid repeated explanation.

The apparatus for cooperative control of the robotic furniture 20 includes a communication unit 21 that receives an input of collected data or communicates with the plurality of robotic furniture modules, and a processor 23 that performs the cooperative control on the plurality of robotic furniture modules 30. The control apparatus 20 may also configure a robotic furniture management system 25 by further providing a sensor 11 that may collect at least one of the image data, the voice data of the user, and the environmental data for the space, and an information collection unit 13 that collects information provided from the robotic furniture module 30.

The processor 23 executes commands including recognizing the situation relating to the user and the object within the space, determining the spatial requirement required for the user, based on the recognized situation, selecting the spatial service that may be cooperatively provided by the plurality of robotic furniture modules in response to the determined spatial requirement, and instructing each of the plurality of robotic furniture modules that may cooperatively provide the selected spatial service to perform the service.

The processor 23 may recognize the situation by collecting at least one of the image data, the voice data of the user, and the environmental data for the space by using the sensor 11, acquiring at least one situational information of the number of users within the space, the individual behavior of the user, the behavior targeting the object of the user, the usage or the quantity of the target objects, the distance between the user and the target object, and the available area within the space, from the collected data, and recognizing the situational context for the user or the target object within the space, based on the acquired situational information.

The processor 23 may determine the spatial requirement suitable for the user within the space with reference to a goal corresponding to the recognized situation and the number of recognized users in a plurality of preset spatial requirements for the space. In addition, the processor 23 may determine the spatial requirement by calculating the space required for the individual behavior in proportion to the number of corresponding users in a case where the behavior of the user is an individual behavior in the recognized situation, and calculating the space required for performing the task on the corresponding target object in a case where the behavior of the user is an object-targeted behavior in the recognized situation.

The processor 23 may select the spatial service by determining the spatial service corresponding to the spatial requirement from among the spatial service candidates that may be provided through the cooperation of the plurality of the robotic furniture modules, and outputting the combination of the robotic furniture modules to achieve the selected spatial service. In addition, the processor 23 may determine the spatial service that may achieve the spatial requirement within the actual space through the movement or the transformation of the robotic furniture module from among the spatial service candidates that may be provided through the cooperation of the plurality of the robotic furniture modules with reference to the available space identified in the recognized situation. In addition, the processor 23 may classify the robotic furniture modules existing within the space in advance into the first height type for providing the seating space to the user and the second height type for providing the work space to the user, may retrieve the plurality of robotic furniture modules suitable for the spatial service with reference to the first height type and the second height type, may check availability of the retrieved robotic furniture modules, and may output a combination of the available resources. Furthermore, the processor 23 may output the combination of the robotic furniture modules by filtering the available resources by checking whether the required space is sufficient within the available space corresponding to the recognized situation in a case where the robotic furniture modules are moved, arranged, transformed, or coupled to perform the service, and selecting the combination having the smallest total cost required for performing the service for each combination of the available resources in a case where there are a plurality of combinations of the filtered available resources.

Meanwhile, the processor 23 may instruct each of the plurality of robotic furniture modules to be moved, arranged, transformed, or coupled to achieve the selected spatial service, and may control the robotic furniture modules to perform sequential or parallel operations under mutual cooperation.

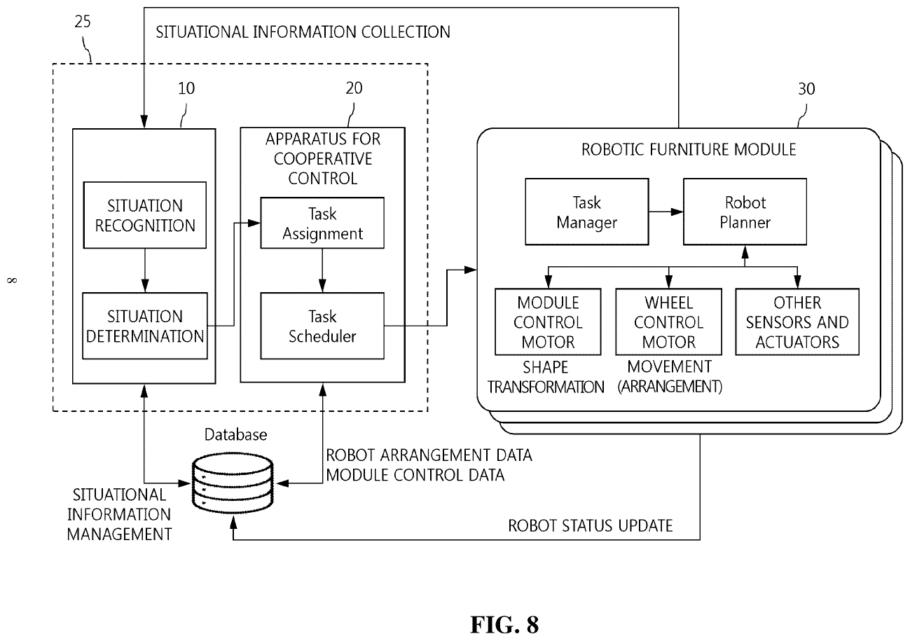

FIG. 8 is a diagram for describing a function or an operation performed by each configuration of the information collection device 10, the apparatus for cooperative control of the robotic furniture 20, and the robotic furniture module 30 in the apparatus for cooperative control in FIG. 7 according to an embodiment of the present disclosure.

For example, the information collection device 10 collects situational information such as data of a camera installed indoors and operation data of cooking utensils. Based on the collected situational information, through situation recognition, the information collection device 10 performs recognition of a person and identity, recognition of whether the cooking utensils are in operation, and the like. Next, through situation determination, the information collection device 10 may determine that the user is in a state of dining with multiple friends, and may determine a type of the furniture suitable for the determined situation and a position to which the furniture needs to be moved. The situation determination result is provided to the apparatus for cooperative control of the robotic furniture 20.

The apparatus for cooperative control of the robotic furniture 20 may set a transformation or combination task for each required furniture module through task assignment. Thereafter, a task plan for each robot may be established through a Task Scheduler, and commands may be delivered to each robot according to a set procedure of the tasks.

The robotic furniture module 30 performs action level planning of the robot suitable for the task delivered through a task manager. Thereafter, the robot is operated according to an action sequence established through a robot planner. In this process, a module control motor, a wheel control motor, and the like may be used to transform each shape or to arrange the module by moving the robot. In addition, other sensors and actuators may be used when necessary. The robotic furniture module 30 may update its own state, and may provide the updated state to the database.

The database may store results of situation recognition or determination, or may store the previously provided state of the robot. In addition, the database may manage situational information in conjunction with the information collection device 10, or may provide robot arrangement data or module control data to the cooperative control apparatus 20.

The robotic furniture module according to embodiments of the present disclosure may be operated in such a manner that a plurality of modules are coupled to or adjacent to each other by using a deformation structure according to at least one or a combination of a Hoberman mechanism, a scissor mechanism, an origami-based mechanism, a pantograph mechanism, a telescopic mechanism, a gear-based deployable mechanism, a magnetic coupling with active latching mechanism, a spherical linkage mechanism, and deployable truss structures. In addition, in order to achieve the selected spatial service. The processor of the apparatus for cooperative control of the robotic furniture may control each of the plurality of robotic furniture modules to perform the service in cooperation with each other by using the deformation structure.

Through various deformation structures, mechanism structures may be designed and adopted in various ways to enable multiple robotic modules to be efficiently operated by being coupled to or arranged adjacent to each other. The deformation structures presented below are structures suitable for optimizing shape transformation, coupling/separation, or adjacent arrangement of the robotic modules, and may be operated in conjunction with a driving unit.
1) The Hoberman mechanism is a mechanism that allows the size of the entire structure to expand and contract in a circular shape or a spherical shape through the movement of connected links. Through the Hoberman mechanism, a distance between the modules may be adjusted or the modules may be arrayed in a specific form by contracting the module in advance before the module is coupled with other robotic modules. Mobility may be improved by reducing a volume through contraction, or a sufficient task area may be secured by expanding the module when being coupled.
2) The scissor mechanism is a mechanism in which a pair of intersecting links are connected by a hinge, and folded or unfolded to generate the movement in a linear or planar direction. Since the scissor mechanism is used, the robotic module expands and contracts. In this manner, the height of the modules may be adjusted to be the same as or different from each other to support the task, or multiple modules may be connected to be used in a platform form, and the modules may be efficiently stacked even in a small space.
3) The origami-based mechanism is a mechanism that may be folded or unfolded into a complex three-dimensional structure in a flat state by applying Origami's principles. The robotic modules may be attached to a specific surface or a connection portion of a folding-type structure. In this manner, through structural transformation, the modules may be coupled to each other, or may have a specific spatial arrangement.
4) The pantograph mechanism is a mechanism that transmits the movement of one point to the movement of another point by expanding or reducing the movement through the connection of parallel links. The robotic modules may be arranged at each connection point of the pantograph mechanism to perform a collaborative task by precisely controlling a relative position or an interval between the modules through the movement of the mechanism. Multiple robotic modules may be arranged at each connection portion of the pantograph structure so that a single driver simultaneously control the shapes or the intervals of the whole robot group.
5) The telescopic mechanism is a mechanism in which a plurality of tubes having a circular shape or a polygonal cross section are inserted into each other to increase or decrease the length in a sliding method. The robotic modules may be mounted on each tube end of the telescopic mechanism to variably adjust a distance between the modules by changing the length of the mechanism, or a specific module may be extended to a desired position to support the user to easily perform the task.
6) The gear-based deployable mechanism is a mechanism for unfolding and folding the structure by using mechanical elements such as gears, racks, and pinions. The robotic modules may be connected to a moving portion of a gear-based deployment structure. The robotic modules may be unfolded or coupled in a desired shape through a rotational motion of the gear, and synchronized transformation or multi-axis expansion are available.
7) The magnetic coupling with active latching mechanism is a structure that couples the robotic modules by using an attraction of a magnet, and more firmly maintains or releases a coupling state through an active latch mechanism. The magnet and the active latch mechanism are integrated with each robotic module. When the modules are closer to each other, self-aligning and coupling are performed due to a magnetic force, and a latch may be operated when necessary. Therefore, a stronger and more stable coupling state may be maintained or released.
8) The spherical linkage mechanism is a mechanism in which multiple links are connected by using spherical joints and which may be connected and expanded through a free rotational motion in a three-dimensional space. The robotic modules may be connected to the links of the spherical linkage mechanisms to achieve complex and organic movements. The robotic modules may have a relative posture and position through the multi-axis rotation of the links, and cooperative movements or operations similar to arms of an articulated robot may be realized.
9) The deployable truss structures are structures in which multiple linear members are connected by hinges to be expandable in a contracted state. The robotic modules may be attached to each node or each member of the deployable truss structures, and the modules may be arranged in a desired shape through deployment and contraction of a truss structure, or may be used to move and install the structure itself.

In order to realize the deformation structure, the deformation of each mechanism may be controlled through a linear actuator or a servo motor. In addition, a Pogo pin array for inter-module communication may be considered during a deformation process. When necessary, each robotic module may include the vision sensor or the RFID for self-recognition and alignment. Therefore, the robotic module may include linkage mechanisms with actuators using actuators. Alternatively, the robotic module may have reconfigurable joints so that the shape and the function may be freely assembled and transformed according to the purpose of use.

The robotic furniture module according to the embodiments of the present disclosure is not fixed to a fixed function like the existing furniture, and has a flexible structure that may freely switch functions according to the situation and the intention of the user. For this purpose, the robotic furniture module is designed so that the shape may be transformed in individual units or various furniture forms may be configured by coupling or separating multiple modules. This characteristic is particularly effective in realizing multiple functions of furniture functions and maximization of space utilization in small residential spaces.

First, there is a method for configuring a new furniture form through coupling or separation of multiple modules. The robotic furniture module may be autonomously moved, arranged, and coupled according to predefined combination rules, and various applications are available accordingly. For example, one square module may be used alone as a side table or a stool. When three square modules are automatically moved, aligned, and coupled, the function is switched to a form of a bench. When four square modules are coupled, the modules are operated in a form of a desk, and may provide the user with a work space. When six to eight square modules are arranged and coupled, the modules are converted into a bed having a large surface and stability.

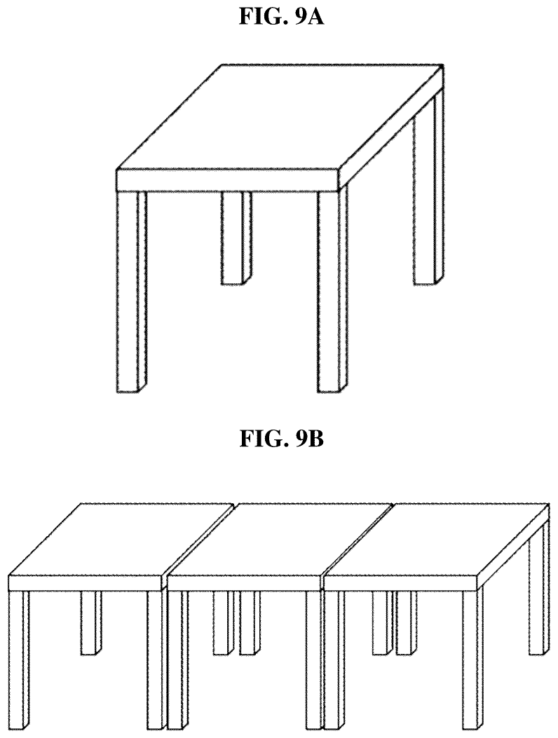

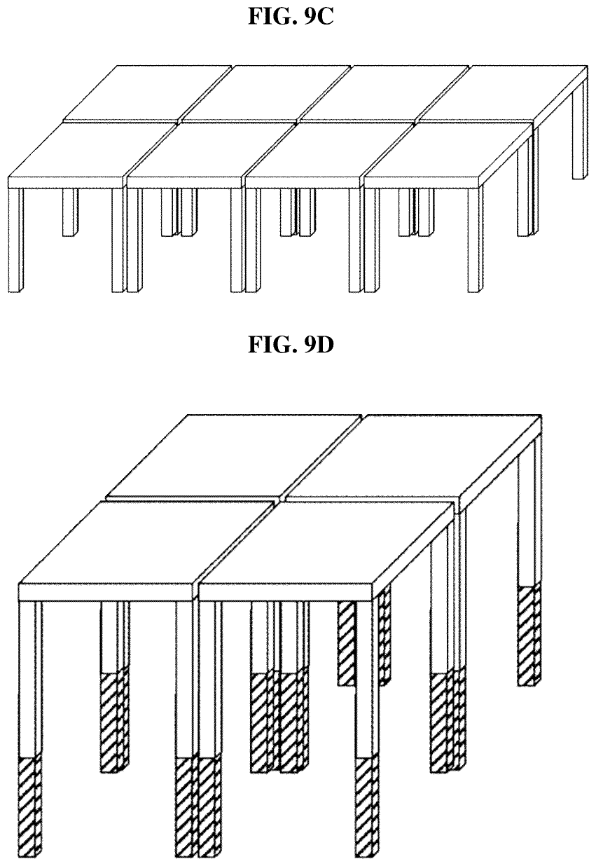

FIGS. 9A to 9D are diagrams showing examples of various roles of the furniture which may be realized from a combination or transformation of the robotic furniture modules. For convenience, a mechanical configuration for the transformation or the movement is omitted in the drawings.

FIG. 9A shows a single robotic furniture module in a form of a square stool. One module may serve as seating means for the user, such as a side table, or such as a shelf on which objects may be placed. FIG. 9B shows that a bench or a long shelf is formed by arranging three square stools side by side. FIG. 9C shows that a bed frame is formed by arranging eight square stools in two rows. The user may place a mat on the bed frame to use the module as a bed. FIGS. 9A to 9C above show that all low furniture modules are used without any change.

Meanwhile, the furniture module in the form of the square stool may be realized as a robotic module having a variable height. In FIG. 9D, four square stools are arranged, and each module is transformed into a high furniture module by extending legs of the stools. GIG. 9D shows that the module may serve as a table.

Next, there is a method for switching functions through shape transformation of a single module. For example, the present disclosure may include a round furniture module to which a two-dimensional Hoberman mechanism connected to multiple links is applied. The module enables structural expansion and contraction, based on 40 or more links. Since mechanical elements such as an umbrella structure focused on Origami and a rack and pinion are applied, functional stability is ensured by using a method of filling an exterior empty space with surface panels. Various functions may be switched by utilizing these structural features. For example, in a state where the Hoberman mechanism is reduced to the maximum, the module may function as a stool or side table. In a state where the Hoberman mechanism is fully expanded, the module may function as a table. In an intermediate form of contraction and expansion, the module may be converted into a storage unit or a cart by using an internal space.

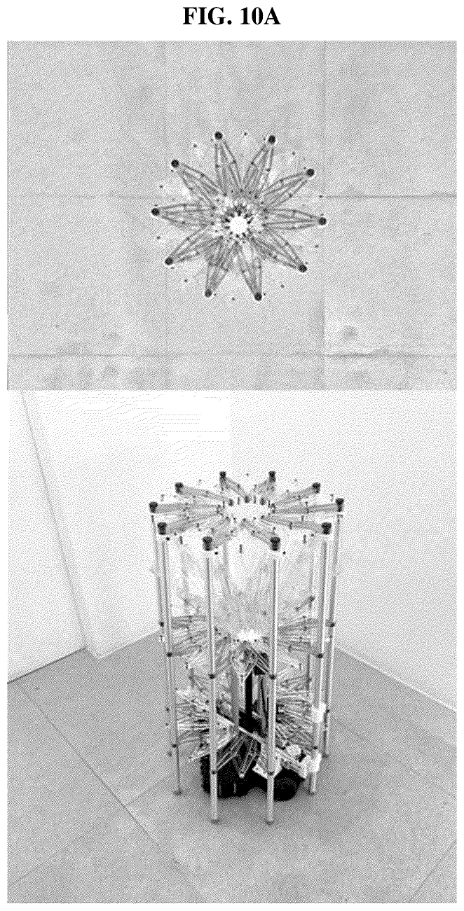

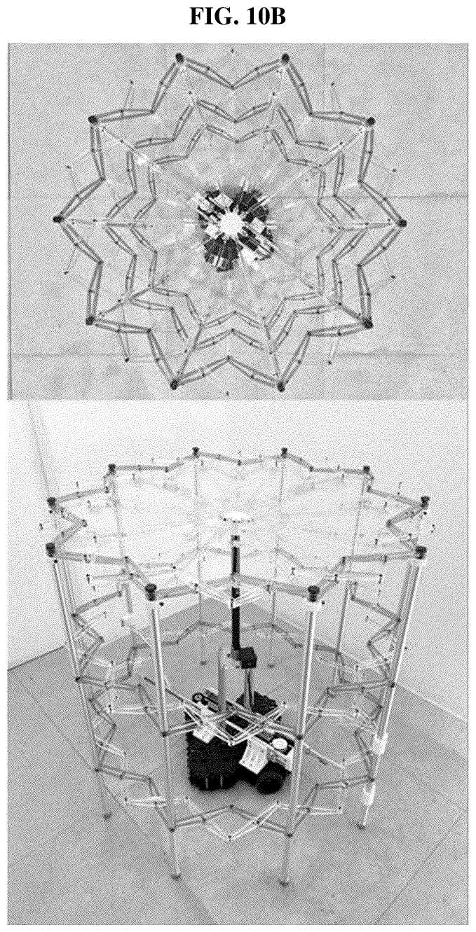

FIGS. 10A and 10B are diagram showing an example of the Hoberman mechanism for shape transformation of the robotic furniture module. FIG. 10A shows a contracted form of the Hoberman mechanism, and FIG. 10B shows an expanded form of the mechanism. The module may function as the stool or the side table when contracted, and the module may function as the table when expanded.

The robotic furniture module according to embodiments of the present disclosure is a modular system that may be transformed and stacked in accordance with a design for maximizing structural flexibility and space utilization efficiency. This furniture module has a circular structure connected by links and joints as a basic shape, and the shape may be flexibly transformed, based on external operation commands or control signals based on situation recognition.

The functions of the module are converted in various ways according to expansion and contraction. At maximum expansion, the module functions as the table by forming a stable support surface, and may be used to place objects or may be used as a work space. In a state of being expanded approximately half, the interior of the structure is formed to be recessed. Therefore, the module may be used as a cart or a storage unit, and may be suitably used to temporarily store or move the objects. At maximum contraction, the size of the module is reduced, and the module may function as the stool or the side table. This shape transformation is realized by transmitting power generated from a motor built into the module to each link structure through a timing belt and a pulley system. Therefore, in response to a command of the user or a result of situational recognition, the module may automatically expand or contract to fulfill the required function.

Furthermore, the robotic furniture module of the present disclosure is designed to be vertically stackable, and a vertical direction of the space may be utilized when necessary. For this purpose, a shaft having a processed screw tap is installed in a central axis of the module. Therefore, the modules are easily coupled with each other without a separate complicated fastening device. Functions may be enlarged in various ways through this stacking structure. For example, when stacked in two stages, the module may have a stable height and support power to be used as a chair. In addition, when stacked in three stages, an upper support surface may be widened to fulfill a function of a table or a cart.

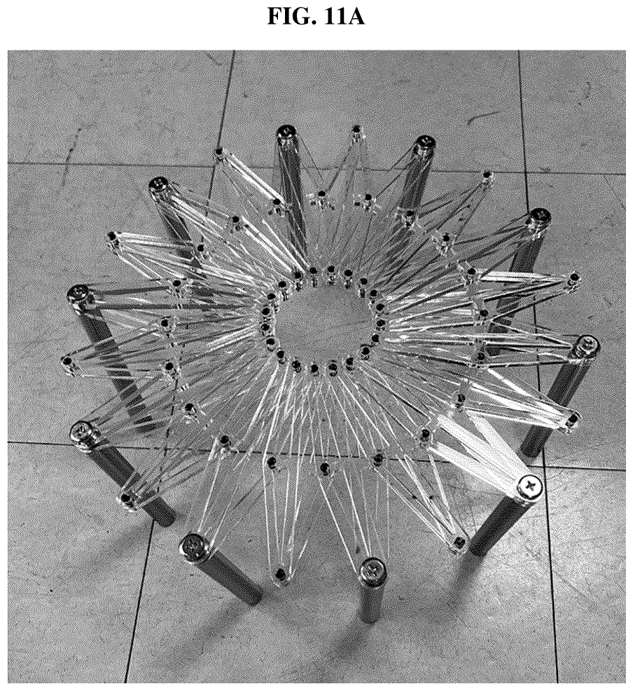

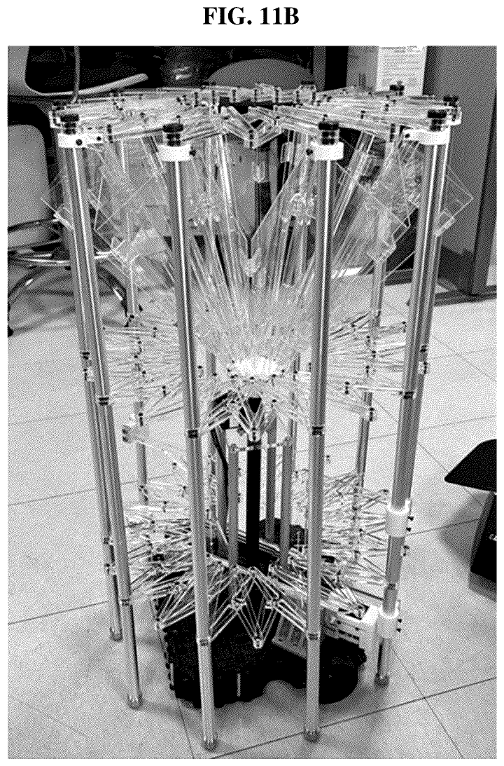

FIGS. 11A and 11B are diagrams showing an example of a prototype of a transformable and stackable robotic furniture module. FIG. 11A shows a base portion of a module which is stackable in a vertical direction, and FIG. 11B shows that the modules are stacked in 3 layers to form a table.

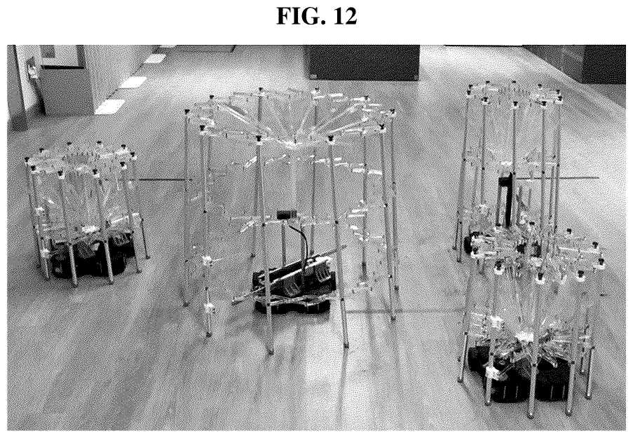

FIG. 12 is a diagram showing an example of a furniture arrangement for multiple users by using the robotic furniture module adopting the Hoberman mechanism. FIG. 12 shows that the contracted furniture modules having mutually different heights, including the table in the center, are arranged adjacent to each other.

In this way, since a single module may be converted to various furniture functions through shape transformation and vertical stacking, the user may efficiently use the furniture while occupying only as much space as the number of modules which may fulfill the desired function when necessary. According to this configuration, the furniture may be flexibly arranged and used in a small living space, space utilization may be maximized. Therefore, this configuration greatly contributes to realization of user-customized spatial service. In particular, the robotic furniture module of the present disclosure may flexibly provide various furniture functions suitable for the situations, based on a precise transformation mechanism using a single module and a cooperative combination mechanism between multiple modules.

Embodiments according to the present disclosure may be realized by various means, for example, hardware, firmware, software, or a combination thereof. In a case of realization by the hardware, an embodiment of the present disclosure may be realized by one or more application specific integrated circuits (ASICs), digital signal processors (DSPs), digital signal processing devices (DSPDs), programmable logic devices (PLDs), field programmable gate arrays (FPGAs), a processor, a controller, a micro controller, a micro processor, and the like. In a case of realization by the firmware or the software, an embodiment of the present disclosure may be realized in a form of modules, procedures, functions, and the like that perform capabilities or operations described above. A software code may be stored in a memory to be driven by the processor. The memory is located inside or outside the processor, and data may be exchanged with the processor by using various means already known.

Meanwhile, embodiments of the present disclosure may be realized on a computer-readable recording medium with computer-readable codes. The computer-readable recording medium includes any type of recording device for storing data that may be read by a computer system. Examples of computer-readable recording media include a ROM, a RAM, a CD-ROM, a magnetic tape, a floppy disk, an optical data storage device, and the like. In addition, the computer-readable recording medium is distributed in a computer system connected via a network, and a computer-readable code may be stored and executed in a distributed manner. In addition, functional programs, codes, and code segments for realizing the embodiments may be easily inferred by programmers in the technical field to which the present disclosure pertains.

In summary, in one or more non-transitory computer-readable media that store one or more instructions, one or more commands executable by one or more processors may recognize a situation relating to a user and an object within a space, based on collected data, may determine a spatial requirement required for the user, based on the recognized situation, may select a spatial service that may be cooperatively provided by a plurality of robotic furniture modules in response to the determined spatial requirement, and may instruct each of the plurality of robotic furniture modules that cooperatively provide the selected spatial service to perform the service.

According to the embodiments of the present disclosure described above, an intention or a request of a user may be actively identified without a command of the user by determining the spatial requirement, based on situation recognition, and the service may be instructed by dynamically selecting the spatial service that may be cooperatively provided by the robotic furniture modules. In this manner, the embodiments of the present disclosure may provide functional flexibility suitable for the user-oriented spatial service and space through cooperation and autonomous control between multiple robotic furniture modules.

In the robotic furniture system according to the embodiments of the present disclosure, multiple modules are cooperatively controlled, and the shape and the function may be dynamically adjusted according to the requirement of the user and space constraints. In particular, a single furniture module may be converted to various functions such as a storage unit, a table, a chair, and a cart, and a plurality of modules may be developed into a more complex furniture structure such as a bench, a desk, and a bed through the combination or the stacking. According to this configuration, a high level of space utilization and multifunctional furniture operation are available even in a small residential environment.

Unlike the existing fixed-type furniture, the robotic furniture according to the embodiments of the present disclosure may autonomously recognize the intention and the situation of the user, based not only on the explicit commands of the user but also on voice, image, environmental data, and the like, and may select and realize optimal furniture functions accordingly. As a result, the user may intuitively and actively experience the arrangement and the functions of the furniture in accordance with various life scenarios without performing complicated operations.

The robotic furniture module is structurally lightweight, and is designed in a form of ensuring mobility. The robotic furniture module may be automatically moved and rearranged when necessary. In a case where a user changes positions of activities within the space, or in a case where situations for the meeting, the work, or the rest are changed, furniture configurations suitable for the changes may be immediately provided, thereby more smoothly supporting daily activities and social interactions of the user.

The embodiments of the present disclosure may autonomously provide proper spatial services by recognizing and determining various situational information such as the number of users, a behavior type, an object usage status, and an available space within a space on a real-time basis. Through this configuration, a user may experience furniture configurations suitable for the situations without any separate direct input or manual operation, thereby achieving an advantageous effect of fundamentally overcoming limitations of a passive usage and a lack of cooperation of the existing transformable furniture.

In a process of the cooperative control of the robotic furniture module, combinations based on resource filtering and cost optimization in accordance with work priorities and required functions are selected. Through this configuration, an optimal furniture configuration is automatically derived even under limited available resources, and efficiency is improved in terms of energy and time.

As a result, embodiments of the present disclosure may essentially contribute to converting the concept of the furniture from a static structure to an adaptive spatial service system by overcoming spatial restrictions in a modern society such as small residential spaces and providing a technical foundation for realizing a user-oriented smart environment.

Hitherto, various embodiments of the present disclosure have been described. Those skilled in the art to which the present disclosure pertains will appreciate that various embodiments may be realized in modified forms within the scope not departing from the essential characteristics of the present disclosure. Therefore, the disclosed embodiments should be considered from an explanatory point of view rather than from a limited point of view. The scope of the present disclosure appears in the scope of the appended claims rather than the description above, and all differences within the equivalent scope should be interpreted as being included in the present disclosure.

What is claimed is:

1. A method for cooperative control of robotic furniture by a control apparatus having at least one processor, the method comprising:
a step of recognizing, by the control apparatus, a situation relating to a user and an object within a space;
a step of determining, by the control apparatus, a spatial requirement required for a user, based on the recognized situation;
a step of selecting, by the control apparatus, a spatial service cooperatively provided by a plurality of robotic furniture modules in response to the determined spatial requirement; and
a step of instructing, by the control apparatus, each of the plurality of robotic furniture modules which cooperatively provide the selected spatial service to perform the service.

2. The method for cooperative control of robotic furniture of claim 1, wherein the step of recognizing the situation includes:
a step of collecting at least one of image data, voice data of a user, and environmental data for a space by using a sensor;
a step of acquiring, from the collected data, at least one situational information from among the number of users within the space, a user's individual behavior, a behavior targeting an object of the user, a usage or a quantity of a target object, a distance between the user and the target object, and an available area within the space; and
a step of recognizing a situational context for the user or the target object within the space, based on the acquired situational information.

3. The method for cooperative control of robotic furniture of claim 1, wherein the step of determining the spatial requirement includes:
a step of determining a spatial requirement suitable for the user within the space with reference to a goal corresponding to the recognized situation and the number of recognized users from among a plurality of spatial requirements set in advance for the space.

4. The method for cooperative control of robotic furniture of claim 3, wherein the step of determining the spatial requirement includes:
a step of calculating the space required for the individual behavior in proportion to the number of corresponding users within a case where the user's behavior is the individual behavior in the recognized situation; and
a step of calculating the space required for performing a task for the corresponding target object in a case where the user's behavior targets the object in the recognized situation.

5. The method for cooperative control of robotic furniture of claim 1, wherein the step of selecting the spatial service includes:
a step of determining a spatial service corresponding to the spatial requirement from among spatial service candidates provided in cooperation with the plurality of robotic furniture modules; and
a step of outputting a combination of the robotic furniture modules to achieve the selected spatial service.

6. The method for cooperative control of robotic furniture of claim 5, wherein the step for determining the spatial service corresponding to the spatial requirement includes:
a step of a step of determining a spatial service for achieving the spatial requirement within an actual space through movement or transformation of the robotic furniture module, from among spatial service candidates provided in cooperation with the plurality of robotic furniture modules with reference to an available space identified in the recognized situation.

7. The method for cooperative control of robotic furniture of claim 5, wherein the step of outputting the combination of the robotic furniture modules includes:
a step of pre-classifying the robotic furniture module existing within the space into a first height type for providing a seating space to a user and a second height type for providing a work space to the user;
a step of retrieving the plurality of robotic furniture modules suitable for the spatial service with reference to the first height type and the second height type; and
a step of outputting a combination of available resources by checking whether the retrieved robotic furniture module is available.

8. The method for cooperative control of robotic furniture of claim 7, wherein the step of outputting the combination of the robotic furniture modules includes:
a step of filtering the available resources by checking whether the required space is sufficient within the available space corresponding to the recognized situation in a case where the robotic furniture module is moved, arranged, transformed, or coupled to perform a service; and
a step of selecting a combination having a lowest total cost required for performing the service in each combination of the available resources in a case where there are a plurality of combinations of the filtered available resources.

9. The method for cooperative control of robotic furniture of claim 1, wherein the step for indicating the execution of the service includes:
a step of instructing each of the plurality of robotic furniture modules to be moved, arranged, transformed, or coupled to achieve the selected spatial service, and controlling the robotic furniture modules to perform sequential or parallel operations in cooperation with each other.

10. At least one non-transitory computer-readable medium that store at least one instruction, wherein the at least one instruction executable by at least one processor to perform operations comprising:
recognizing a situation relating to a user and an object within a space, based on collected data;
determining a spatial requirement required for a user, based on the recognized situation;
selecting a spatial service cooperatively provided by a plurality of robotic furniture modules in response to the determined spatial requirement; and
instructing each of the plurality of robotic furniture modules for cooperatively providing the selected spatial service to perform the service.

11. An apparatus for cooperative control of robotic furniture, comprising:
a communication unit configured to receive an input of collected data or to communicate with a plurality of robotic furniture modules; and
a processor configured to perform cooperative control of the plurality of robotic furniture modules,
wherein the processor is configured to perform instructions including recognizing a situation relating to a user and an object within a space, determining a spatial requirement required for a user, based on the recognized situation, selecting a spatial service cooperatively provided by the plurality of robotic furniture modules in response to the determined spatial requirement, and instructing each of the plurality of robotic furniture modules for cooperatively providing the selected spatial service to perform the service.

12. The apparatus for cooperative control of the robotic furniture of claim 11, wherein the processor recognizes the situation by collecting at least one of image data, voice data of a user, and environmental data for a space by using a sensor, by acquiring, from the collected data, at least one situational information from among the number of users within the space, an individual behavior of the user, a behavior targeting an object of the user, a usage or a quantity of target objects, a distance between the user and the target object, and an available area within the space, and by recognizing a situational context for the user or the target object within the space, based on the acquired situational information.

13. The apparatus for cooperative control of the robotic furniture of claim 11, wherein the processor determines a spatial requirement suitable for the user within the space with reference to a goal corresponding to the recognized situation and the number of recognized users from among a plurality of spatial requirements set in advance for the space.

14. The apparatus for cooperative control of the robotic furniture of claim 13, wherein the processor determines the spatial requirement by calculating the space required for the individual behavior in proportion to the number of corresponding users within a case where the behavior of the user is the individual behavior in the recognized situation, and by calculating the space required for performing a task for the corresponding target object in a case where the user's behavior targets the object in the recognized situation.

15. The apparatus for cooperative control of the robotic furniture of claim 11, wherein the processor selects the spatial service by determining a spatial service corresponding to the spatial requirement from among spatial service candidates provided in cooperation with the plurality of robotic furniture modules, and by outputting a combination of the robotic furniture modules to achieve the selected spatial service.

16. The apparatus for cooperative control of the robotic furniture of claim 15, wherein the processor determines a spatial service for achieving the spatial requirement within an actual space through movement or transformation of the robotic furniture module, from among spatial service candidates provided in cooperation with the plurality of robotic furniture modules with reference to an available space identified in the recognized situation.

17. The apparatus for cooperative control of the robotic furniture of claim 15, wherein the processor pre-classifies the robotic furniture module existing within the space into a first height type for providing a seating space to a user and a second height type for providing a work space to the user, retrieves the plurality of robotic furniture modules suitable for the spatial service with reference to the first height type and the second height type, and outputs a combination of available resources by checking whether the retrieved robotic furniture module is available.

18. The apparatus for cooperative control of the robotic furniture of claim 17, wherein the processor outputs the combination of the robotic furniture modules by filtering the available resources by checking whether the required space is sufficient within the available space corresponding to the recognized situation in a case where the robotic furniture module is moved, arranged, transformed, or coupled to perform a service, and by selecting a combination having a lowest total cost required for performing the service in each combination of the available resources in a case where there are a plurality of combinations of the filtered available resources.

19. The apparatus for cooperative control of the robotic furniture of claim 11, wherein the processor instructs each of the plurality of robotic furniture modules to be moved, arranged, transformed, or coupled to achieve the selected spatial service, and controlling the robotic furniture modules to perform sequential or parallel operations in cooperation with each other.

20. The apparatus for cooperative control of the robotic furniture of claim 19, wherein the robotic furniture module are operated in such a manner that a plurality of modules are coupled to or adjacent to each other by using a deformation structure according to at least one or a combination of a Hoberman mechanism, a scissor mechanism, an origami-based mechanism, a pantograph mechanism, a telescopic mechanism, a gear-based deployable mechanism, a magnetic coupling with active latching mechanism, a spherical linkage mechanism, and deployable truss structures, and in order to achieve the selected spatial service, the processor controls each of the plurality of robotic furniture modules to perform the service in cooperation with each other by using the deformation structure.
